(19) United States
(12) Patent Application Publication
(10) Pub. No.: US 2012/0160203 A1
(43) Pub. Date: Jun. 28, 2012

(54) Piston for an internal combustion engine

(75) Inventor: Rainer Scharp, Vaihingen (DE)

(73) Assignee: MAHLE International GmbH, Stuttgart (DE)

(21) Appl. No.: 13/066,552

(22) Filed: Apr. 18, 2011

(30) Foreign Application Priority Data
Dec. 24, 2010 (DE) 10 2010 056 218.1

(51) Int. Cl. F02F 3/26; F02F 3/16

(52) U.S. Cl. 123/193.6

(57) ABSTRACT

The present invention relates to a piston (10, 110, 210) for an internal combustion engine, having a first piston component (11) and a second piston component (12), whereby the first piston component (11) and the second piston component (12) form a circumferential cooling channel (23) that is open toward the second piston component, which channel is closed off by means of a circumferential closure element. According to the invention, it is provided that the closure element (25, 125, 225) is connected with the first piston component (11) and extends radially in the direction of the second piston component (12), that the second piston component (12) has a circumferential contact flange (26, 126, 226) that extends radially in the direction of the first piston component (11), and that the closure element (25, 125, 225) lies on the contact flange (26, 126, 226) or that the closure element (325) supports itself on a face surface (331) of the contact flange (326) with a circumferential lower edge (329).

The present invention relates to a piston for an internal combustion engine, having a first piston component and a second piston component, whereby the first piston component and the second piston component form a circumferential cooling channel that is open toward the second piston component, which channel is closed off by means of a circumferential closure element.

Pistons having such a cooling channel are known. The cooling channel of such a piston is closed off by means of a circumferential, two-part sheet-metal ring. The disadvantage of this arrangement consists in that two loose additional components are required for the production of the cooling channel.

The task of the present invention therefore consists in configuring a piston having such a cooling channel in such a manner that its production is simplified.

The solution consists in that the closure element is connected with the first piston component and extends radially in the direction of the second piston component, that the second piston component has a circumferential contact flange that extends radially in the direction of the first piston component, and that the closure element lies on the contact flange or that the closure element supports itself on a face surface of the contact flange with a circumferential lower edge.

It is therefore provided, according to the invention, that the closure element is configured as a structural element of the first piston component. In this way, a sheet-metal ring for closing the cooling channel is no longer required, so that an assembly step for the production of the piston according to the invention is eliminated, and the piston no longer has any loose components.

Advantageous further developments are evident from the dependent claims.

The closure element is preferably configured in one piece with the first piston component, in order to further simplify the production process. Of course, the closure element can also be produced as a separate component and connected with the first piston component in fixed manner. In corresponding manner, it is preferred that the contact flange is in one piece with the second piston component.

The radial width of the closure element and of the contact flange can be dimensioned to be the same size or different sizes. In particular, the radial width of the contact flange can be greater than the radial width of the closure element.

Preferably, the closure element lies on the contact flange with bias, in order to seal the cooling channel off in particularly reliable manner. In this case, in particular, it is practical if the face surface of the contact flange is disposed inclined in the direction toward the closure element, in order to optimize sealing of the cooling channel. However, the closure element and the contact flange can also be connected with one another by means of a joining method, for example welding or soldering.

It is practical if at least one coolant entry opening and at least one coolant exit opening are provided in the closure element and/or in the contact flange.

The first and the second piston component are preferably connected with one another by means of a friction-welding method.

A particularly preferred further development consists in that the first piston component is a piston ring element that has at least a part of a piston crown, a circumferential top land, as well as a circumferential ring belt provided with ring grooves. In this case, it is particularly practical if the closure element is connected with the first piston component in the region of a lower, free end of the ring belt.

The first piston component can have a combustion chamber bowl. However, the first piston component can also have at least a wall region of a combustion chamber bowl, while the second piston component has at least a crown region of a combustion chamber bowl.

The second piston component is preferably configured as a piston base body, particularly preferably for a box piston, which body has at least a piston skirt with pin bosses that are provided with pin bores.

Preferably, the piston skirt is configured to be thermally uncoupled from the ring belt.

Exemplary embodiments of the invention will be explained in greater detail below, using the attached drawings. These show, in a schematic representation, not true to scale:

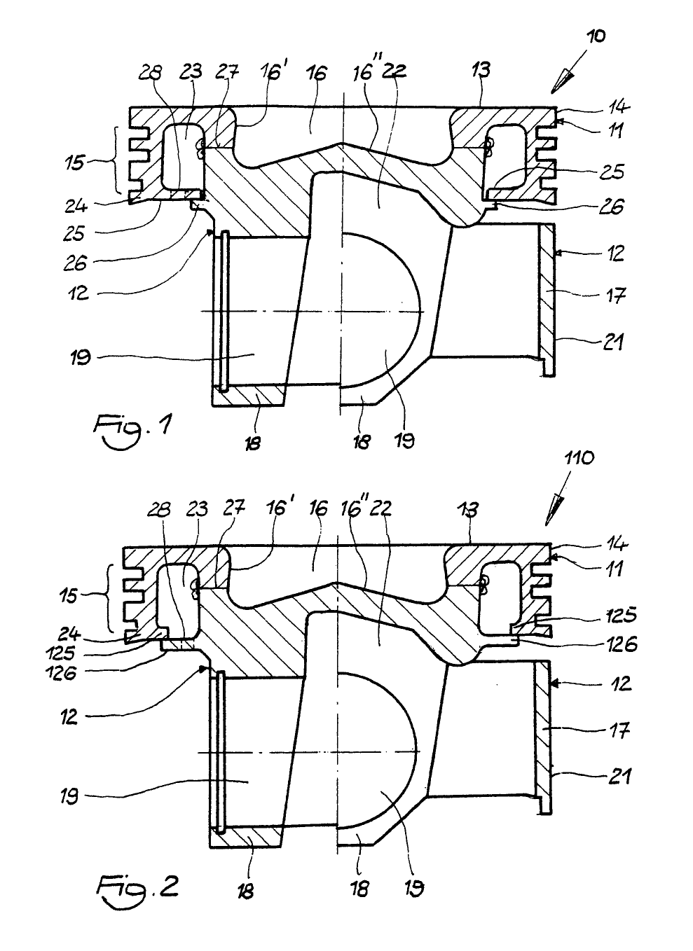

FIG. 1 an exemplary embodiment of a piston according to the invention, in section;

FIG. 2 another exemplary embodiment of a piston according to the invention, in section;

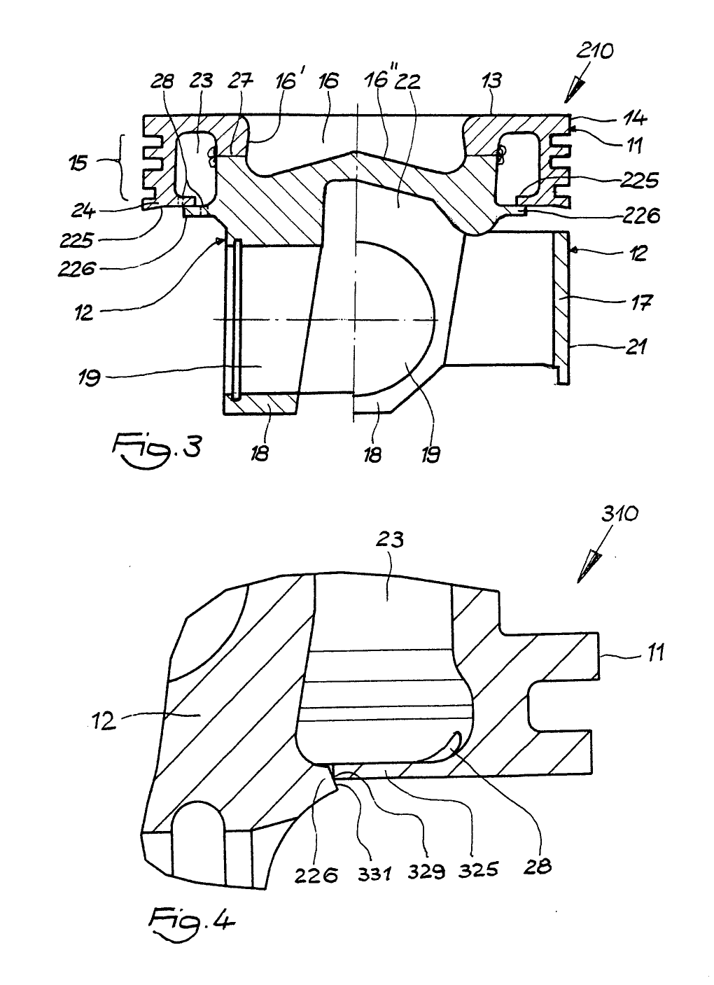

FIG. 3 another exemplary embodiment of a piston according to the invention, in section;

FIG. 4 a detail view of another exemplary embodiment of a piston according to the invention, in section.

FIG. 1 shows a first exemplary embodiment of a piston 10 according to the invention. The piston 10 consists of a first piston component 11 and a second piston component 12. In the present exemplary embodiment, the first piston component 11 is configured as a piston ring element, and the second piston component 12 is configured as a piston base body for a box piston. Other divisions are also possible, as long as the ring belt 15 (see below) is formed by the first piston component 11 at least in the region of its free end 24 (see below). Both components can consist of any suitable metallic material.

In the exemplary embodiment, the first piston component 11 has a piston crown 13 as well as a circumferential top land 14 and a circumferential ring belt 15 having ring grooves for accommodating piston rings (not shown). The first piston component 11 furthermore forms a wall region 16′ of a combustion chamber bowl 16.

In the present exemplary embodiment, the second piston component 12 forms a piston skirt 17 that is thermally uncoupled from the ring belt 15, which skirt is provided, in known manner, with pin bosses 18 and pin bores 19 for accommodating a piston pin (not shown). The pin bosses 18 are connected with one another by way of working surfaces 21. The second piston component 12 furthermore forms a crown region 16″ of the combustion chamber bowl 16. The pin bosses 18 are tied into the underside of the combustion chamber bowl 16 by way of pin boss links 22.

The first piston component 11 and the second piston component 12 are connected with one another by way of a joining seam 27, by means of friction welding, in the exemplary embodiment. The joining seam 27 is disposed in the region of the combustion chamber bowl 16 in the exemplary embodiment. However, this is not compulsory; the important thing is that the ring belt 15 is formed by the first piston component 11 at least in the region of its free end 24 (see below).

The ring belt 15 of the first piston component 11, together with the second piston component 12, forms a circumferential cooling channel 23 that is open toward the piston skirt 17, in known manner. In order to close off the cooling channel 23, the ring belt 15 has a closure element 25 at its free, lower end 24. The closure element 25 extends radially in the direction of the second piston component 12 and is connected in one piece with the free end 24 of the ring belt 15 of the first piston component 11, in the exemplary embodiment. The second piston component 12 has a circumferential contact flange 26 approximately at the height of the pin boss links 22, in the exemplary embodiment, which flange is in one piece with the second piston component 12.

The closure element 25 and the contact flange 26 are dimensioned in such a manner that after the first piston component 11 and the second piston component 12 are joined, the closure element 25 lies on the contact flange 26. In this connection, the closure element 25 can lie on the contact flange 26 in relaxed manner or under bias. In the latter case, a particularly reliable seal of the cooling channel 23 exists. The closure element 25 and the contact flange 26 can also be additionally connected with one another by means of joining, for example welding or soldering.

In the exemplary embodiment shown in FIG. 1, the radial width of the closure element 25 is dimensioned to be greater than the radial width of the contact flange 26, and extends almost over the entire cross-section of the cooling channel 23 in this individual case. For this reason, the openings 28 for entry and exit of the coolant are introduced into the closure element 25.

FIG. 2 shows another exemplary embodiment of a piston 110 according to the invention. The piston 110 corresponds to the piston 10 according to FIG. 1, to a great extent, so that the same reference symbols are provided for the same structural elements, and reference is made, in this regard, to the description of FIG. 1.

The essential difference as compared with the exemplary embodiment shown in FIG. 1 consists in that the radial width of the closure element 125 is dimensioned to be smaller than the radial width of the contact flange 126. In this exemplary embodiment, the contact flange 126 extends almost over the entire cross-section of the cooling channel 23. For this reason, the openings 28 for entry and exit of the coolant are introduced into the contact flange 126.

FIG. 3 shows another exemplary embodiment of a piston 210 according to the invention. The piston 210 corresponds to the piston 10 according to FIG. 1, to a great extent, so that the same reference symbols are provided for the same structural elements, and reference is made, in this regard, to the description of FIG. 1.

The essential difference as compared with the exemplary embodiment shown in FIG. 1 consists in that the radial width of the closure element 225 corresponds approximately to the radial width of the contact flange 226. For this reason, the openings 28 for entry and exit of the coolant are introduced not only into the closure element 225 but also into the contact flange 226.

FIG. 4 shows a detail view of another exemplary embodiment of a piston 310 according to the invention. The piston 310 corresponds to the piston 10 according to FIG. 1, to a great extent, so that the same reference symbols are provided for the same structural elements, and reference is made, in this regard, to the description of FIG. 1.

The essential difference as compared with the exemplary embodiment shown in FIG. 1 consists in that the closure element 325 has a circumferential lower edge 329 and the contact flange 326 has a face surface 331. The face surface 331 of the contact flange 326 is disposed inclined in the direction toward the closure element 325. The circumferential lower edge 329 of the closure element 325 supports itself, if necessary under bias, on the face surface 331 of the contact flange 326. In this connection, the openings 28 for entry and exit of the coolant are introduced into the closure element 325.

1. Piston (10, 110, 210, 310) for an internal combustion engine, having a first piston component (11) and a second piston component (12), whereby the first piston component (11) and the second piston component (12) form a circumferential cooling channel (23) that is open toward the second piston component (12), which channel is closed off by means of a circumferential closure element, wherein the closure element (25, 125, 225, 325) is connected with the first piston component (11) and extends radially in the direction of the second piston component (12), wherein the second piston component (12) has a circumferential contact flange (26, 126, 226, 326) that extends radially in the direction of the first piston component (11), and wherein the closure element (25, 125, 225) lies on the contact flange (26, 126, 226) or wherein the closure element (325) supports itself on a face surface (331) of the contact flange (326) with a circumferential lower edge (329).

2. Piston according to claim 1, wherein the closure element (25, 125, 225, 325) is configured in one piece with the first piston component (11).

3. Piston according to claim 1, wherein the contact flange (26, 126, 226, 326) is configured in one piece with the second piston component (12).

4. Piston according to claim 1, wherein the radial width of the closure element (25, 125, 225, 325) and of the contact flange (26, 126, 226, 326) is dimensioned to be the same size or different sizes.

5. Piston according to claim 1, wherein the closure element (25, 125, 225) lies on the contact flange (26, 126, 226) under bias, or wherein the closure element (325) supports itself on the contact flange (326) under bias.

6. Piston according to claim 1, wherein the face surface (331) of the contact flange (326) is disposed inclined in the direction toward the closure element (325).

7. Piston according to claim 1, wherein the closure element (25, 125, 225, 325) and the contact flange (26, 126, 226, 326) are connected with one another by means of a joining method.

8. Piston according to claim 1, wherein at least one coolant entry opening (28) and at least one coolant exit opening (28) are provided in the closure element (25, 125, 225, 325) and/or in the contact flange (26, 126, 226, 326).

9. Piston according to claim 1, wherein the first piston component (11) and the second piston component (12) are connected with one another by means of a friction-welding method.

10. Piston according to claim 1, wherein the first piston component (11) is a piston ring element that has at least a part of a piston crown (13), a circumferential top land (14), as well as a circumferential ring belt (15) provided with ring grooves.

11. Piston according to claim 9, wherein the closure element (25, 125, 225, 325) is connected with the first piston component (11) in the region of a lower, free end of the ring belt (15).

12. Piston according to claim 9, wherein the first piston component (11) has a combustion chamber bowl.

13. Piston according to claim 9, wherein the first piston component (11) has at least a wall region (16′) of a combustion chamber bowl (16) and wherein the second piston component (12) has at least a crown region (16″) of a combustion chamber bowl (16).

14. Piston according to claim 1, wherein the second piston component (12) is a piston base body that has at least a piston skirt (17) having pin bosses (18) that are provided with pin bores (19).

15. Piston according to claim 1, wherein the piston skirt (17) is configured to be thermally uncoupled from the ring belt (15).
